(19) United States
(12) Patent Application Publication
(10) Pub. No.: US 2012/0133272 A1
(43) Pub. Date: May 31, 2012

(54) ORGANIC EL DISPLAY APPARATUS

(75) Inventors: Junya Tamaki, Chiba-shi (JP); Takashi Moriyama, Funabashi-shi (JP); Nobuhiko Sato, Mobara-shi (JP)

(73) Assignee: CANON KABUSHIKI KAISHA, Tokyo (JP)

(21) Appl. No.: 13/291,280

(22) Filed: Nov. 8, 2011

(30) Foreign Application Priority Data
Nov. 25, 2010 (JP) 2010-261917

(51) Int. Cl. H05B 33/14

(52) U.S. Cl. 313/504

(57) ABSTRACT

Provided is an organic EL display apparatus in which, depending on a situation in which a user uses the organic EL display apparatus, “display with high light use efficiency and high front luminance (luminous efficiency)” or “display with large view angle” is selectable. Pixels each include subpixels having different optical characteristics from each other, and the pixels and the subpixels are respectively arranged in a staggered pattern. Further, the subpixels are independently controlled.

### BACKGROUND OF THE INVENTION

1. Field of the Invention

The present invention relates to an organic electroluminescence (EL) display apparatus, which uses an organic EL device.

2. Description of the Related Art

In organic EL display apparatuses, multiple pixels each including an organic EL device are arranged in matrix on a substrate. In each of the pixels, the organic EL device is connected in series to a driving thin film transistor (TFT) for driving the organic EL device and a power line for supplying power to the organic EL device. The organic EL device emits light in response to the power supplied from the power line, and the emitted light exits outside the organic EL display apparatus.

Low light extraction efficiency is known as one of the problems of the organic EL device. This is caused because, in the organic EL device, light exits from a light emitting layer at various angles, and hence a large number of total reflection components are generated at an interface between a protection layer and an external space, which causes confinement of emitted light inside the device. In order to solve this problem, various structures have been proposed. Japanese Patent Application Laid-Open No. 2004-039500 discloses a structure in which a lens array made of a resin is arranged on a silicon oxynitride (SiNₓO_{y}) film for sealing the organic EL device, to thereby improve the light extraction efficiency in the front direction.

In the structure including the lens array disclosed in Japanese Patent Application Laid-Open No. 2004-039500, it is possible to improve front luminance of the display apparatus by a light condensing effect. Meanwhile, the luminance of the display apparatus in an oblique direction is reduced, and hence a large view angle cannot be obtained. Further, the above-mentioned problem occurs not only in the organic EL device using the lens array, but also in an organic EL device provided with a buffering effect. In this case, the luminance increases in a direction in which a constructive interference effect is obtained, while the luminance reduces in a direction in which a destructive interference effect is obtained. This structure also cannot obtain a large view angle.

Depending on the situation in which the user uses the organic EL display apparatus, a large view angle may be required. However, in such a situation, it is difficult to use the structure in which the lens array is provided on the organic EL device.

### SUMMARY OF THE INVENTION

It is an object of the present invention to provide an organic EL display apparatus which uses an organic EL device, in which, depending on a situation in which a user uses the organic EL display apparatus, “display with high light use efficiency and high front luminance (luminous efficiency)” or “display with large view angle” is selectable.

The present invention provides an organic EL display apparatus, including multiple pixels, each of the multiple pixels including: a first subpixel and a second subpixel having the same hue and different optical characteristics; an organic EL device corresponding to the first subpixel and an organic EL device corresponding to the second subpixel; and a driving TFT for supplying a current to the organic EL device corresponding to the first subpixel and the organic EL device corresponding to the second subpixel, in which the first subpixel has a higher front luminance than the second subpixel, in which the first subpixel and the second subpixel of the each of the multiple pixels are independently controlled to emit light by the same gradation display signal, and in which the multiple pixels and the first subpixels of the multiple pixels are respectively arranged in a staggered pattern.

According to the present invention, in the organic EL display apparatus, the pixels each include the multiple subpixels having different optical characteristics, and light emission periods of the respective subpixels are independently controlled. With this, depending on the situation in which the user uses the organic EL display apparatus, the “display with high front luminance (luminous efficiency)” or the “display with large view angle” is selectable.

Further, in the drive using only the subpixel with high front luminance, the equivalent luminance as that of the subpixel without high front luminance can be obtained using a low current, and hence lower power consumption is achieved.

Further, by driving the multiple subpixels having different optical characteristics at the same time or in time series, while maintaining the view angle characteristics, the light use efficiency can be enhanced.

Further, according to the present invention, the pixels are arranged in a staggered pattern, and the multiple subpixels are respectively arranged in the staggered patterns. With this, an organic EL display apparatus with high sense of resolution can be provided. Further, because the pixels are arranged in a staggered pattern, the gate lines for the light emission period controlling TFTs may be arranged without intersecting with each other, and the gate lines may be formed in a single layer. With this, the parasitic capacitances of the gate lines are prevented from being increased, and the rise and fall delay of the gate control signal can be reduced, and it is also possible to provide an organic EL display apparatus capable of reducing the manufacturing cost or possibility of wiring short circuit.

Further features of the present invention will become apparent from the following description of exemplary embodiments with reference to the attached drawings.

### BRIEF DESCRIPTION OF THE DRAWINGS

FIG. 1 is a view schematically illustrating a structure of an organic EL display apparatus according to an embodiment of the present invention.

FIGS. 2A and 2B are views schematically illustrating a pixel arrangement and a wiring connection form, respectively, of the organic EL display apparatus according to the embodiment of the present invention.

FIGS. 3A and 3B are views schematically illustrating a sectional structure of one pixel of the organic EL display apparatus according to the embodiment of the present invention.

FIG. 4 is a graph illustrating an angle dependence of luminance of the organic EL display apparatus according to the embodiment of the present invention.

FIG. 5 is a diagram illustrating a pixel circuit of the organic EL display apparatus according to the embodiment of the present invention.

FIG. 6 is a timing chart illustrating a driving sequence of the organic EL display apparatus of the present invention, provided with the pixel circuit of FIG. 5.

FIGS. 7A and 7B are views schematically illustrating a pixel arrangement and a wiring connection form, respectively, of an organic EL display apparatus as a comparative example.

### DESCRIPTION OF THE EMBODIMENTS

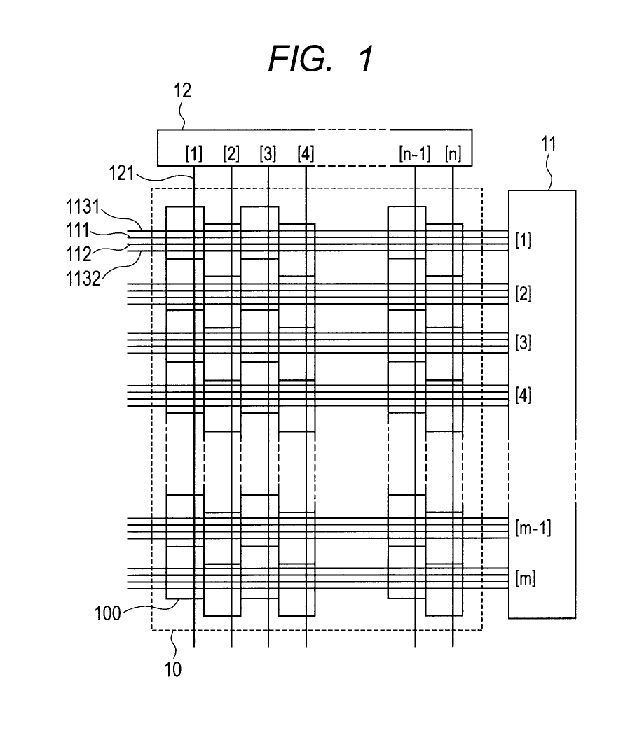

Hereinafter, an embodiment of the present invention is described in detail with reference to the drawings. FIG. 1 is a plan view schematically illustrating a structure of an organic electroluminescence display apparatus (organic EL display apparatus) according to the embodiment of the present invention. As illustrated in FIG. 1, the organic EL display apparatus of this embodiment includes a display region 10 in which multiple pixels 100 are arranged in matrix of (m rows)×(n columns), and a row control circuit 11 and a column control circuit 12, which are provided in a periphery of the display region 10. Here, “m” and “n” are natural numbers. A pixel circuit of each of the pixels 100 within the display region includes an organic EL device, and a transistor (for example, thin film transistor (TFT)) for controlling a current to be supplied to the organic EL device. The arrangement of subpixels of each of the pixels 100 is described later. Further, the organic EL device represents a structure including two electrodes, and an organic compound layer including a light emitting layer, the organic compound layer being arranged between the two electrodes.

From respective output terminals of the row control circuit 11, multiple gate control signals P1(1) to P1(m), P2(1) to P2(m), P31(1) to P31(m), and P32(1) to P32(m) are output. The gate control signal P1 is input via a gate line 111, the gate control signal P2 is input via a gate line 112, the gate control signal P31 is input via a gate line 1131, and the gate control signal P32 is input via a gate line 1132 to the pixel circuit of each of the rows. A video signal is input to the column control circuit 12, and a data voltage Vdata, which is a gradation display signal, and a reference voltage Vsl are output from each output terminal. The data voltage Vdata, which is the gradation display signal, and the reference voltage Vsl are input via a data line 121 to the pixel circuit of each of the columns. Note that, data wiring for outputting the data voltage and reference voltage wiring for outputting the reference voltage may be separately provided and the connection may be switched therebetween. The data voltage input as the gradation display signal takes a voltage value between a minimum gradation display signal voltage corresponding to black display and a maximum gradation display signal voltage corresponding to white display, thereby performing gradation display.

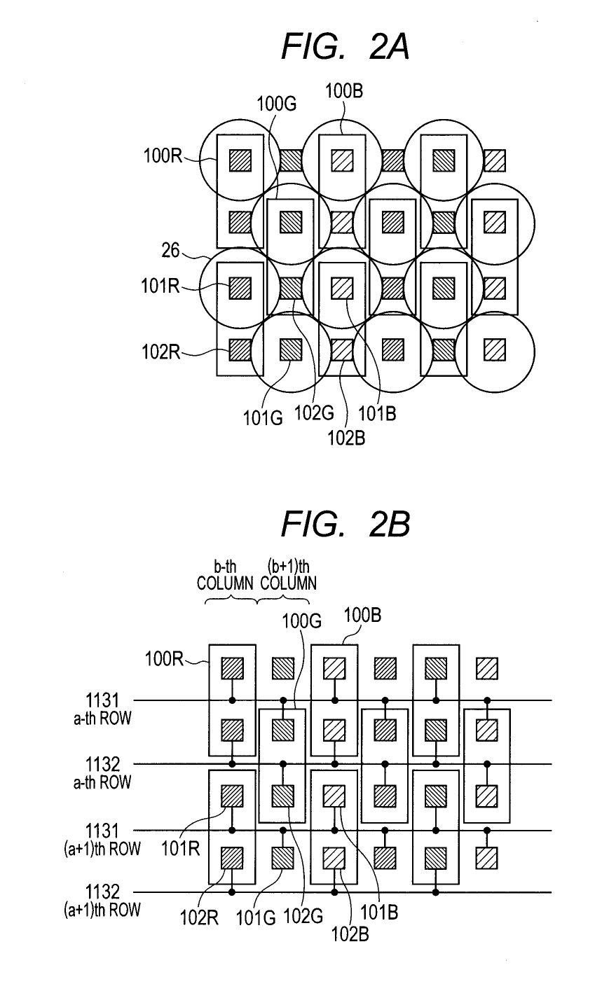

The pixel structure and the pixel arrangement of the organic EL display apparatus of this embodiment are described with reference to FIG. 2A. The organic EL display apparatus of this embodiment includes pixels 100R, 1000, and 100B having three different hues of red (R), green (G), and blue (B), respectively. As illustrated in FIG. 2A, those pixels are arranged within the display region in a planar state. Further, each of the pixels 100 within the display region includes multiple subpixels having the same hue and different optical characteristics. The subpixel represents a region in which, in a direction perpendicular to the substrate, the organic compound layer is directly held in contact with and sandwiched between a reflection electrode and an upper electrode described later. In this embodiment, the pixel 100R includes a first subpixel 101R and a second subpixel 102R, the pixel 100G includes a first subpixel 101G and a second subpixel 102G, and the pixel 100B includes a first subpixel 101B and a second subpixel 102B.

The first subpixel 101 is formed of a pixel circuit including a first organic EL device and a TFT for controlling a current to be supplied to the first organic EL device. The second subpixel 102 is formed of a pixel circuit including a second organic EL device and a TFT for controlling a current to be supplied to the second organic EL device.

In each of the pixels 100, the pixel circuit of the first subpixel 101 and the pixel circuit of the second subpixel 102 of the corresponding pixel share at least a driving TFT. Therefore, in each of the pixels 100, the first organic EL device of the first subpixel 101 and the second organic EL device of the second subpixel 102 of the corresponding pixel are driven by the same driving TFT.

In this embodiment, the first subpixel 101 is a subpixel in which front luminance is increased by providing a lens (condenser lens) above the organic EL device as described later, and the second subpixel 102 is a subpixel without a lens, which has a view angle larger than that of the first subpixel 101.

In the present invention, the pixels 100 are arranged in a staggered pattern (staggered arrangement). Here, the staggered arrangement represents an arrangement in which, when attention is paid on a pixel in a n-th column, a pixel in a (n+1)th column, and a pixel in a (n+2)th column, on a straight line connecting two pixels selected from those three pixels, a center of gravity of each of the three pixels is not positioned. In relation to the pixels provided in the staggered arrangement as described above, positions of the subpixels 101 and 102 having different optical characteristics within each pixel 100 are the same in all of the pixels 100, and in FIGS. 2A and 2B, the subpixels 101 and 102 are positioned on the upper side and the lower side, respectively. That is, the subpixels 101 and 102 are also respectively arranged in staggered patterns. As described above, the pixels 100 are provided in the staggered arrangement, and further, the positions of the subpixels 101 and 102 having different optical characteristics within each pixel are the same in all of the pixels so that the subpixels 101 and 102 are also respectively arranged in the staggered patterns.

In other words, the pixels, the subpixels 101, and the subpixels 102 are respectively arranged in the staggered patterns. With this structure, as illustrated in FIGS. 2A and 2B, the positions of the subpixels 101 and 102 are shifted every column in the column direction, and hence it is possible to perform display with higher sense of resolution in the column direction.

Further, in the arrangement capable of performing display with higher sense of resolution as described above, as described later, it is possible to arrange wiring for connecting a light emission period controlling TFT and a gate line for inputting a control signal to the light emission period controlling TFT so as not to intersect with a gate line for inputting a control signal to a light emission period controlling TFT for another subpixel within the same pixel.

Further, in this embodiment, in the arrangement capable of performing display with higher sense of resolution as described above, a lens 26 is arranged above the first organic EL device of each of the first subpixels 101 provided in the staggered arrangement. That is, as illustrated in FIG. 2A, the lenses 26 are also provided in the staggered arrangement. When the lenses 26 are provided in the staggered arrangement as described above, compared to a structure in which the lenses 26 are arranged in a linear pattern, the lens diameter can be increased to be about 1.6 times larger than that of the above-mentioned structure, and the range which contributes to light condensing by the lenses can be increased to be about 2.5 times larger than that of the above-mentioned structure. That is, the light condensing effect of the lenses can be enhanced.

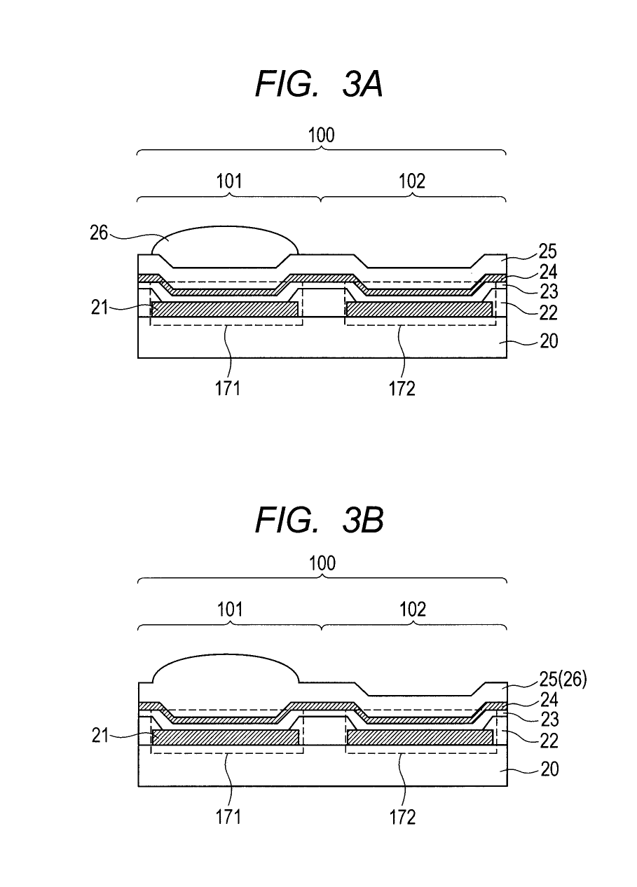

FIGS. 3A and 3B are views schematically illustrating a sectional structure of one pixel region of the organic EL display apparatus of this embodiment. As illustrated in FIG. 3A, the organic EL display apparatus of this embodiment includes a substrate 20 on which a circuit element portion (not shown) is formed. The circuit element portion includes a switching TFT (not shown), the driving TFT (not shown), and wiring structures (not shown) of the gate line including a scanning signal line, the data line, and the power line. On the circuit element portion, a planarizing layer (not shown) is formed. In the planarizing layer, a contact hole (not shown) for electrically connecting an electrode formed above the planarizing layer and the circuit element portion is formed.

In the display region 10, a reflection electrode is formed on the planarizing layer. The reflection electrode 21 is connected to the driving TFT via the contact hole. The reflection electrode 21 is preferred to be a light reflective member, and for example, a material such as Cr, Al, Ag, Au, and Pt may be used. By using a light reflective member as the reflection electrode 21, the light extraction efficiency can be improved. Further, the reflection electrode 21 may also be structured so that a reflex function is secured by such a light reflective member as described above, and a function as an electrode is secured by a transparent conductive film such as an ITO film formed on the light reflective member. The reflection surface of the reflection electrode 21 in this case is the surface of the light reflective member. As a method of forming and patterning the reflection electrode, a well-known method may be applied. The reflection electrode is separately provided in each of the first subpixel 101 and the second subpixel 102, and each reflection electrode is connected to the circuit element portion. In this manner, a first organic EL device 171 and a second organic EL device 172 can be driven independently.

On the reflection electrode 21, a bank 22 is formed so as to cover the edge of the reflection electrode 21. The bank 22 is provided with an opening portion so that a center portion of the reflection electrode 21 is exposed. As a material of the bank 22, a well-known material such as an acrylic resin and a polyimide resin may be used. In the opening portion on the reflection electrode 21, an organic compound layer (organic EL layer) 23 is formed. The organic compound layer 23 is formed by an evaporation method using a shadow mask. The organic compound layer 23 includes the light emitting layer, and in addition thereto, may include a hole injection layer, a hole transport layer, an electron transport layer, an electron injection layer, and the like. An organic layer including the light emitting layer, which forms the organic compound layer 23, may be made of a well-known material.

On the organic compound layer 23, a semi-transparent upper electrode 24 is formed. As the upper electrode 24, a transparent conductive film such as an ITO film, or a semi-transmissive film formed of a metal material such as Ag and Al having a thickness of about 10 nm to 30 nm may be used. The upper electrode 24 is formed by a well-known method such as an evaporation method and a sputtering method. The upper electrode 24 is connected to the circuit element portion via a contact portion (not shown) outside the display region 10.

The reflection electrode 21, the organic compound layer 23, and the upper electrode 24 described above form each of the organic EL devices 171 and 172 in the subpixels 101 and 102, respectively.

On the upper electrode 24, a sealing layer 25 for protecting the organic EL devices 171 and 172 from moisture and oxygen is formed. The sealing layer 25 includes an inorganic layer made of an inorganic material. The sealing layer 25 may have a single inorganic layer structure, or a structure in which an inorganic layer and an organic layer, which is made of an organic resin and the like, are laminated. For the inorganic layer in the sealing layer 25, a well-known inorganic material such as silicon nitride may be used. The thickness of the inorganic layer is preferred to be 0.1 μm or larger and 10 μm or smaller, and the inorganic layer is preferred to be formed by a sputtering method, a CVD method, and other similar methods. With this, the organic EL device can be successfully covered, and protection performance can be improved. Further, in the structure in which the organic resin is laminated, the thickness of the organic resin is preferred to be 1 μm or larger so as to cover unremovable foreign matters adhered on the surface during the process to improve the protection performance. Note that, in FIG. 3A, the protection layer is formed along the shape of the bank 22, but alternatively may be formed so that the surface thereof is flat. With the use of the organic material, the surface can be formed flat.

In this embodiment, further, the lens (condenser lens) 26 is formed above the first organic EL device 171 of the first subpixel 101. The surface above the second organic EL device 172 is flat. With this structure, the light emitted from the first organic EL device 171 is condensed by the lens 26, and thus the front luminance of the first subpixel 101 becomes higher than that of the second subpixel 102.

The lens 26 is formed by processing a resin material. Specifically, the lens 26 can be formed by embossing. Other than embossing, the lens may be formed by any one of the following methods i) to v).

i) A method in which a resin layer patterned by photolithography is subjected to thermal treatment, to thereby deform the resin layer into the lens shape by a reflow process.

ii) A method in which a photo-curable resin layer formed to have a uniform thickness is exposed with light having distribution in an in-plane direction, and then the resin layer is developed, to thereby form the lens.

iii) A method in which, with the use of an ion beam, an electron beam, or a laser, a surface of a resin material formed to have a uniform thickness is processed into the lens shape.

iv) A method in which a moderate amount of resin is dropped on each pixel to form the lens in a self-aligning manner.

v) A method in which a resin sheet on which the lens is formed in advance is prepared separately from the substrate on which the organic EL device is formed, and both the resin sheet and the substrate are aligned and then adhered to each other, to thereby form the lens.

In a case where the protection layer 25 is formed to have a multilayer form and an organic resin is used as a part of the layers, the resin may be processed into the lens shape. In this case, the sectional structure as illustrated in FIG. 3B is obtained. The use of resin enables formation of the flat surface, and a region without the lens can also be formed flat as illustrated in FIG. 3B.

With this structure, in the first organic EL device 171 above which the lens 26 is formed, the light emitted from the organic compound layer 23 passes through the upper electrode 24. Subsequently, the light passes through the protection layer 25 and the lens 26, and exits outside the organic EL display apparatus. In the structure in which the lens 26 is formed, compared to the case where the lens is omitted, the exit angle becomes closer to a direction perpendicular to the substrate. Therefore, the light condensing effect in the direction perpendicular to the substrate is more improved in a case where the lens 26 is provided. That is, as for the display apparatus, the light use efficiency in the front direction can be enhanced. Further, in the structure in which the lens 26 is formed, an incident angle of light obliquely emitted from the light emitting layer with respect to an exit interface becomes closer to a right angle, and hence an amount of light performing total reflection reduces. As a result, light extraction efficiency can also be improved.

Meanwhile, in the organic EL device 172 without the lens, light obliquely emitted from the light emitting layer of the organic compound layer 23 exits from the protection layer 25 in a manner further inclined.

In this embodiment, the subpixels 101 and 102 are formed as described above to have different optical characteristics. The first subpixel 101 is a subpixel with high front luminance due to the light condensing effect of the lens, and the second subpixel 102 is a subpixel with large view angle, in which the light condensing by the lens is not performed.

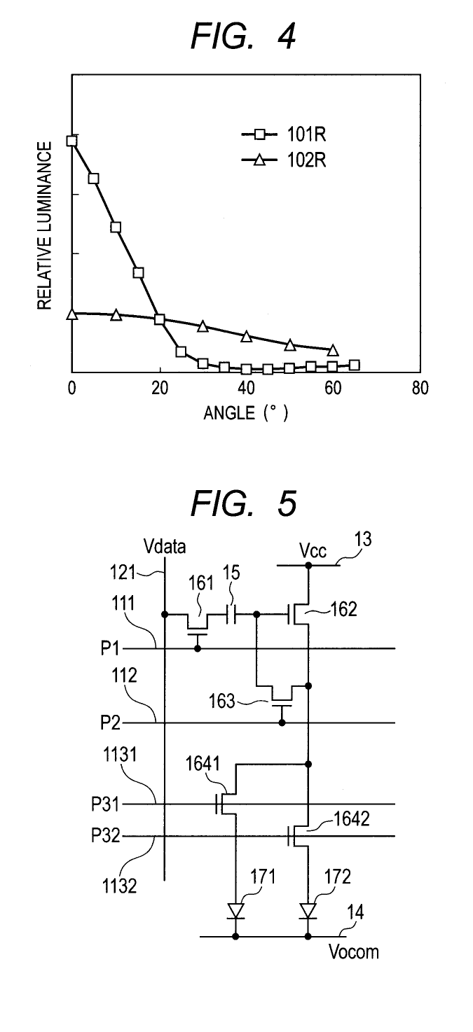

FIG. 4 is a graph illustrating an angle dependence of luminance of each of the first subpixel 101R and the second subpixel 102R in the pixel 100R. In FIG. 4, the front luminance of the second subpixel 102R is set as 1, and the luminance at an angle inclined from the front side is represented as a relative luminance value. As illustrated in FIG. 4, the first subpixel 101R exhibits optical characteristics of high front luminance, and the second subpixel 102R exhibits optical characteristics of large view angle. Also in the pixel 100G and the pixel 100B, similar characteristics are obtained in the case of the same structure.

In the present invention, the specific example of the structure in which the multiple subpixels, which form the pixel, have different optical characteristics from each other is not limited to the above-mentioned structure in which the lens is provided on the light emitting surface side of the organic EL device in one of the subpixels. For example, the organic EL devices 171 and 172 may be organic EL devices having different optical interference conditions, to thereby increase the front luminance of one of the subpixels (first subpixel).

Hereinafter, a driving method and a wiring arrangement of the organic EL display apparatus of this embodiment are described.

FIG. 5 is a diagram illustrating a configuration example of the pixel circuit of each of the pixels in the organic EL display apparatus according to the embodiment of the present invention. The organic EL display apparatus of this embodiment includes, as illustrated in FIG. 5, in each pixel, a selecting TFT 161 as the switching TFT, an erasing TFT 163, a first light emission period controlling TFT 1641, and a second light emission period controlling TFT 1642. Further, the organic EL display apparatus of this embodiment includes a driving TFT 162, a holding capacitor 15, the first organic EL device 171, and the second organic EL device 172. Further, to the pixel circuit, a power line 13, the data line 121, and the gate lines 111, 112, 1131, and 1132 are connected. Further, in this embodiment, the selecting TFT 161, the first light emission period controlling TFT 1641, the second light emission period controlling TFT 1642, and the erasing TFT 163 are each an N-type TFT, and the driving TFT 162 in a P-type TFT.

In the organic EL display apparatus of this embodiment, as illustrated in FIG. 5, a part constituted of the selecting TFT 161, the erasing TFT 163, the driving TFT 162, the holding capacitor 15, the power line 13, the data line 121, and the gate lines 111 and 112 is shared between the first subpixel 101 and the second subpixel 102. Further, further on a point at which a drain terminal of the driving TFT 162 is connected to one terminal of the erasing TFT 163, the part is divergingly connected to the first light emission period controlling TFT 1641 and the second light emission period controlling TFT 1642.

Hereinafter, the connection form is described in detail.

The selecting TFT 161 has a gate terminal connected to the gate line 111, one terminal connected to the data line 121, and the remaining terminal connected to the holding capacitor 15.

The erasing TFT 163 has a gate terminal connected to the gate line 112, and one terminal connected to a gate terminal of the driving TFT 162. Further, the remaining terminal of the erasing TFT 163 is connected to the drain terminal of the driving TFT 162, a drain terminal of the first light emission period controlling TFT 1641, and a drain terminal of the second light emission period controlling TFT 1642.

The driving TFT 162 has a source terminal connected to the power line 13, and the drain terminal connected to the remaining terminal of the erasing TFT 163, the drain terminal of the first light emission period controlling TFT 1641, and the drain terminal of the second light emission period controlling TFT 1642.

The first light emission period controlling TFT 1641 and the second light emission period controlling TFT 1642 have gate terminals connected to the gate line 1131 and the gate line 1132, respectively, and source terminals connected to an anode of the first organic EL device 171 and an anode of the second organic EL device 172, respectively. The first organic EL device 171 and the second organic EL device 172 each have a cathode connected to a ground line 14. The holding capacitor 15 is arranged between the selecting TFT 161 and the gate terminal of the driving TFT 162 as well as the one terminal of the erasing TFT 163.

In the organic EL display apparatus of this embodiment, the organic EL device 171 corresponds to the first subpixel 101 and the organic EL device 172 corresponds to the second subpixel 102. The organic EL devices 171 and 172 are controlled to emit light by the first light emission period controlling TFT 1641 and the second light emission period controlling TFT 1642, respectively. In the structure of this embodiment, the gate terminal of the first light emission period controlling TFT 1641 and the gate terminal of the second light emission period controlling TFT 1642 are connected to the independent gate lines 1131 and 1132, respectively. As a result, with the gate control signals P31 and P32, the first subpixel 101 and the second subpixel 102 can be independently controlled to emit light. Therefore, the first subpixel 101 and the second subpixel 102 may turn on or turn off at the same time, or may be driven to independently turn on or turn off. Further, the first organic EL device 171 and the second organic EL device 172 are supplied with a current from the same driving TFT 162, and hence the light emission is controlled by the same gradation display signal.

When the first subpixel 101 and the second subpixel 102 are independently driven, in a case where only the second subpixels 102 turn on, display with large view angle is achieved. Further, in a case where only the first subpixels 101 turn on, although the view angle decreases, display with high front luminance is achieved. Further, by driving the first subpixel 101 with high front luminance at a low current, the same luminance as that of the pixel without high front luminance can be obtained using a low current, and hence lower power consumption is achieved.

Therefore, in the organic EL display apparatus of this embodiment, depending on the necessity of the user, “display with high light use efficiency and high front luminance”, “display with large view angle”, or “display with lower power consumption” is selectable.

When the first subpixel 101 and the second subpixel 102 are driven at the same time, owing to the first subpixel 101 with the high front luminance, the front luminance can be increased, and owing to the second subpixel 102 with the large view angle, reduction of luminance in the oblique direction can be suppressed so that the view angle characteristics are improved. That is, while maintaining the view angle characteristics, the display with high light use efficiency is achieved.

Next, a wiring connection form and a wiring arrangement of the organic EL display apparatus of the present invention are described.

FIG. 2B is a view schematically illustrating the wiring connection form and the wiring arrangement of the organic EL display apparatus according to the embodiment of the present invention. In FIG. 2B, illustration of the lenses, which are illustrated in FIG. 2A, is omitted. Further, as for the gate lines, only the gate lines 1131 and 1132 for the light emission period controlling TFTs are illustrated, and illustration of the gate lines 111 and 112 for the selecting TFT and the erasing TFT is omitted. In FIG. 2B, the black circles represent nodes.

In the organic EL display apparatus of the present invention, the pixels 100 are provided in the staggered arrangement, and in relation to the pixels provided in the staggered arrangement, the positions of the subpixels 101 and 102 having different optical characteristics within each pixel are the same in all of the pixels so that the subpixels 101 and 102 are also respectively provided in the staggered arrangement. As a result, the pixels in each row are arranged so as to be shifted every column in the column direction by an amount corresponding to half the pixel (by an amount corresponding to the subpixel). The arrangement position of the pixel 100 in the a-th row and (b+1)th column in the column direction is between the arrangement position of the pixel 100 in the a-th row and b-th column in the column direction and the arrangement position of the pixel 100 in the (a+1)th row and b-th column in the column direction. Further, the arrangement position of the pixel 100 in the a-th row and (b+2)th column in the column direction is between the arrangement position of the pixel 100 in the (a−1)th row and (b+1)th column in the column direction and the arrangement position of the pixel 100 in the a-th row and (b+1)th column in the column direction. In other words, the arrangement position of the pixel 100 in the a-th row and (b+2)th column in the column direction is the same as the arrangement position of the pixel 100 in the a-th row and b-th column in the column direction. Further, the gate line 1131 of the a-th row is arranged between the first subpixel 101 and the second subpixel 102 within the pixel 100 in the a-th row and b-th column, and is also arranged between the second subpixel 102 of the pixel 100 in the (a−1)th row and (b+1)th column and the first subpixel 101 of the pixel 100 in the a-th row and (b+1)th column. Further, the gate line 1132 of the a-th row is arranged between the second subpixel 102 of the pixel 100 in the a-th row and b-th column and the first subpixel 101 of the pixel 100 in the (a+1)th row and b-th column, and is also arranged between the first subpixel 101 and the second subpixel 102 within the pixel 100 in the a-th row and (b+1)th column. Here, “a” and “b” are natural numbers.

With this structure, without intersecting with the gate line 1132, the gate line 1131 can be connected to the gate terminal of the light emission period controlling TFT 1641 of the first subpixel 101 provided with the lens of each of the pixels. Further, without intersecting with the gate line 1131, the gate line 1132 can be connected to the gate terminal of the light emission period controlling TFT 1642 of the second subpixel 102 without the lens of each of the pixels.

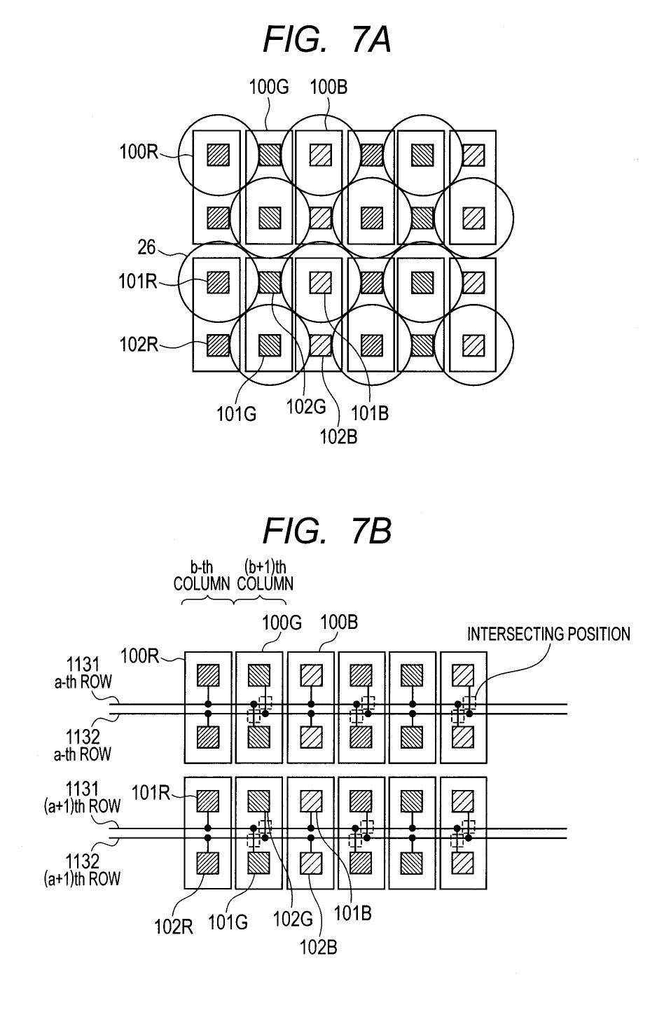

With reference to FIG. 7A as an example, the pixel arrangement, the wiring connection form, and the wiring arrangement of a comparative example of this embodiment are described. Except for the pixel arrangement, the wiring connection form, and the wiring arrangement, an organic EL display apparatus of this comparative example is similar to the organic EL display apparatus of the present invention in the layer structure, the pixel circuit, and the like of the display apparatus. The different points are described below.

In this comparative example, the pixels 100 are arranged in a linear pattern in any of the row direction and the column direction. In relation to the pixels arranged in a linear pattern, the positions of the subpixels 101 and 102 having different optical characteristics within each pixel are alternately changed in the b-th column and the (b+1)th column. In FIGS. 7A and 7B, upper and lower positions are alternated in the row direction. With this, the subpixels 101 and 102 are respectively provided in the staggered arrangement, and similarly to the present invention, the display with high sense of resolution is achieved. That is, only the subpixels are provided in the staggered arrangement. Further, the lens is arranged above the organic EL device in each of the first subpixels 101 provided in the staggered arrangement, and the lenses 26 are also provided in the staggered arrangement. In this manner, the lens diameter can be increased to be about 1.6 times larger than that of a structure in which the lenses 26 are arranged in a linear pattern, and the range which contributes to light condensing by the lenses can be increased to be about 2.5 times larger than that of the above-mentioned structure. That is, the light condensing effect of the lenses 26 can be enhanced.

FIG. 7B is a view schematically illustrating the wiring connection form and the wiring arrangement of the organic EL display apparatus of this comparative example. In FIG. 7B, illustration of the lenses, which are illustrated in FIG. 7A, is omitted. Further, as for the gate lines, only the gate lines 1131 and 1132 for the light emission period controlling TFTs are illustrated. Illustration of the gate lines 111 and 112 for the selecting TFT and the erasing TFT is omitted.

In the organic EL display apparatus of this comparative example, the pixels are arranged in a linear pattern. Therefore, in order to connect the gate terminals of the light emission period controlling TFTs 1641 and 1642 with the gate lines 1131 and 1132, respectively, as illustrated in FIG. 7B, the gate lines 1131 and 1132 corresponding to the a-th row are arranged so as to pass through the pixels 100 in the a-th row. When the gate lines 1131 and 1132 are formed of a single layer, there is generated, in every other column, a position at which a wiring route connecting the gate line 1131 via the light emission period controlling TFT 1641 to the first organic EL device 171 intersects with the gate line 1132. Similarly, there is generated, in every other column, a position at which a wiring route connecting the gate line 1132 via the light emission period controlling TFT 1642 to the second organic EL device 172 intersects with the gate line 1131.

As a result, in the organic EL display apparatus of this comparative example, the wiring structures at those intersecting positions are required to be set as described below. For example, the gate lines 1131 and 1132 are formed of two layers, and an insulating layer is disposed between the two layers. Alternatively, the light emission period controlling TFTs 1641 and 1642 are required to be connected to the organic EL devices 171 and 172, respectively, with wiring formed in a different layer from that of the gate lines in a manner passing across the gate lines 1132 and 1131.

At the intersecting positions, in any of the above-mentioned wiring structures, due to a parasitic capacitance generated between the gate line 1131 or 1132 and the wiring intersecting therewith, a parasitic capacitance of the gate line 1131 or 1132 increases. Therefore, rise and fall delay may occur in the gate control signal P31 or P32.

The gate control signals are input from the row control circuit 11 in the periphery of the display region 10, and in this comparative example, the intersecting positions are generated in the gate line 1131 or 1132 in every other column. As a result, the above-mentioned rise and fall delay of the gate control signal P31 or P32 becomes larger toward inside of the display region 10. Therefore, luminance unevenness may occur.

Further, in a case of forming the gate lines 1131 and 1132 of two layers and disposing an insulating layer between the two layers, the manufacturing cost increases.

Further, in a case where a layer different from that of the gate lines is used as the wiring connecting the light emission period controlling TFTs 1641 and 1642 and the organic EL devices 171 and 172 while passing across the gate lines 1132 and 1131, respectively, the following problem occurs. That is, because new wiring is formed in the layer, the possibility of short circuit particularly between the new wiring and wiring in the same layer increases due to foreign matters and the like produced during the manufacturing process.

In the organic EL display apparatus of the comparative example, the subpixels 101 and 102 are respectively provided in the staggered arrangement, to thereby achieve the display with high sense of resolution and the increase of the lens diameter. However, in the comparative example, the pixels are arranged in a linear pattern, and the positions of the subpixels 101 and 102 within each pixel are changed every column. As a result, there are generated, in every other column, positions at which wirings connecting the gate lines 1131 and 1132 and the gate terminals of the light emission period controlling TFTs 1641 and 1642 of the subpixels 101 and 102 intersect with the gate lines 1132 and 1131, respectively.

On the other hand, in the organic EL display apparatus of the present invention, the pixels 100 are provided in the staggered arrangement. Further, in relation to the pixels provided in the staggered arrangement, the positions of the subpixels 101 and 102 having different optical characteristics within each pixel are the same in all of the pixels so that the subpixels 101 and 102 are also respectively provided in the staggered arrangement. With this structure, the gate terminals of the light emission period controlling TFTs 1641 and 1642 of the subpixels 101 and 102 are connected to the gate lines 1131 and 1132 without intersecting with the gate lines 1132 and 1131, respectively. Specifically, one of the gate lines 1131 and 1132 is arranged between the first subpixel 101 and the second subpixel 102 within the pixel 100, and the other of the gate lines 1131 and 1132 is arranged between the adjacent pixels. More specifically, in the b-th column, the gate line 1131 is arranged between the first subpixel 101R and the second subpixel 102R within the pixel 100R, and the gate line 1132 is arranged between the adjacent two pixels 100R. In the (b+1)th column, the gate line 1131 is arranged between the adjacent two pixels 1000, and the gate line 1132 is arranged between the first subpixel 101G and the second subpixel 102G within the pixel 100G. With this, it is possible to prevent increase of the above-mentioned parasitic capacitance of the gate lines 1131 and 1132. Further, the gate lines 1131 and 1132 can be formed of a single layer. With this, the problems described above, that is, the increase of the manufacturing cost and the increase of the possibility of the wiring short circuit, are prevented from being generated.

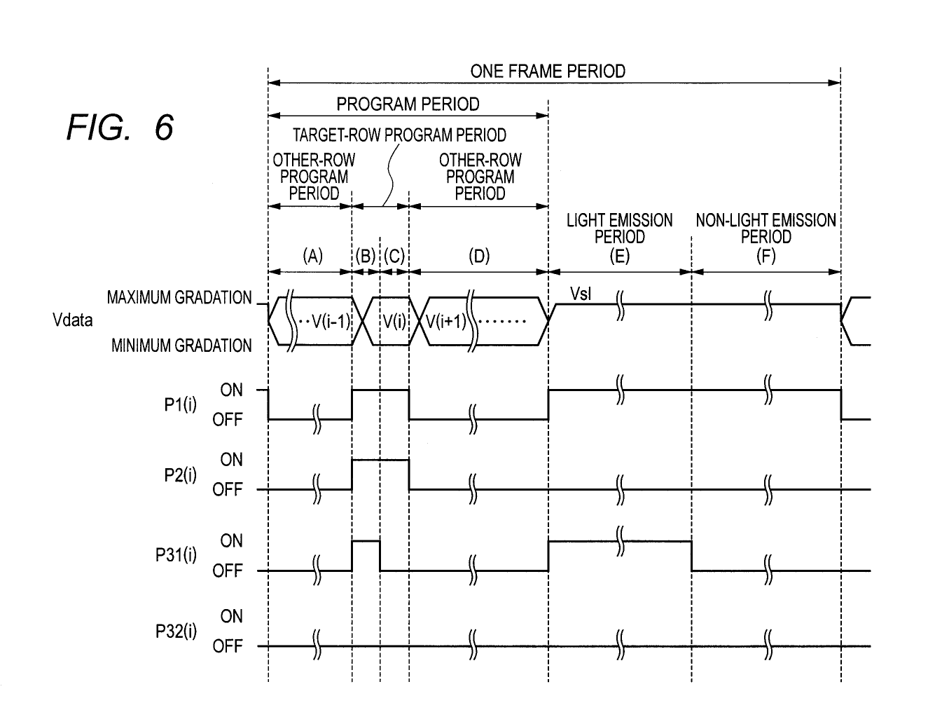

FIG. 6 illustrates an example of a timing chart of a driving sequence of the pixel circuit in the i-th row of the organic EL display apparatus of the present invention, provided with the pixel circuit of FIG. 5. The driving sequence in this embodiment includes, within one frame, program periods (A) to (D) during which the gradation display signal is written to each of the pixels. Further, the remaining period is divided into, at an arbitrary ratio, a light emission period (E) during which an organic EL device of a target pixel emits light and a non-light emission period (F) during which the organic EL device of the target pixel is controlled not to emit light.

The periods (A) to (D) corresponding to a program period relate to a target row of a target column, and are separated into target-row program periods (B) and (C) during which the gradation display signal is written to the target pixel and other-row program periods (A) and (D) during which the gradation display signal is written to pixels in rows other than the target row. The target-row program period is constituted of a discharge period (B) and a write period (C). V(i−1), V(i), and V(i+1) represent pieces of the data voltage Vdata input to the pixel circuit in the (i−1)th row (row preceding the target row), the pixel circuit in the i-th row (target row), and the pixel circuit in the (i+1)th row (row following the target row), respectively, in the target column during one frame period.

Hereinafter, operations during respective periods in the driving sequence are described.

(A) Other-Row Program Period (Prior to Target-Row Program Period)

During this period, in the pixel circuit in the target row, a Low level (L level) signal is input to the gate line 111 as P1(i), and the selecting TFT 161 is in an OFF state. Further, the L level signal is input to the gate line 112 as P2(i), and the erasing TFT 163 is in the OFF state. Under this state, the data voltage V(i−1), which is the gradation display signal related to the preceding row, is not input to the pixel circuit in the i-th row, which is the target row. The L level signals are input to both the gate lines 1131 and 1132, and both the light emission period controlling TFTs 1641 and 1642 are in the OFF state.

(B) Discharge Period

During this period, High level (H level) signals are input to the gate lines 111, 112, and 1131, and the selecting TFT 161, the erasing TFT 163, and the light emission period controlling TFT 1641 are in an ON state. The L level signal is input to the gate line 1132, and the light emission period controlling TFT 1642 is in the OFF state. Further, the data voltage V(i), which is the gradation display signal of the target row, is set to the data line 121, and the data voltage V(i) is input to the terminal of the holding capacitor 15 connected on the data line side.

Because the erasing TFT 163 is turned ON, the gate terminal of the driving TFT 162 and the ground line 14 are connected to each other via the light emission period controlling TFT 1641 and the organic EL device 171. Then, the gate voltage of the driving TFT 162 becomes, regardless of the voltage value in the last minute, a voltage close to a ground line potential Vocom to turn ON the driving TFT 162.

(C) Write Period

During this period, the L level signals are input to the gate lines 1131 and 1132, and the light emission period controlling TFTs 1641 and 1642 are in the OFF state. With this, a current flows from the drain terminal to the gate terminal of the driving TFT 162, and a gate-source voltage of the driving TFT 162 becomes close to a threshold voltage of the driving TFT 162. To the terminal of the holding capacitor 15 connected to the gate terminal of the driving TFT 162, the gate voltage of the driving TFT 162 at this time is input. Further, continuously from the period (B), the data voltage V(i), which is the gradation display signal of the target row, is set to the data line 121, and the data voltage V(i) is input to the terminal of the holding capacitor 15 connected on the data line side. The holding capacitor 15 is charged by an amount corresponding to a voltage of a difference between the gate voltage of the driving TFT 162 and the data voltage V(i), and thus the program of the gradation display signal is performed.

(D) Other-Row Program Period (After Target-Row Program Period)

During this period, the L level signals are input to the gate lines 111, 112, 1131, and 1132, and the selecting TFT 162, the erasing TFT 163, and the light emission period controlling TFTs 1641 and 1642 are in the OFF state. Therefore, even when the data line voltage is changed to the data voltage V(i+1), which is the gradation display signal related to the following row, charges in the holding capacitor 15, which is charged during the period (C), are held.

(E) Light Emission Period

During this period, the H level signal is input to the gate line 111, and the selecting TFT 161 is in the ON state. Further, the reference voltage Vsl is set to the data line 121. As a result, the reference voltage Vsl is input to the terminal of the holding capacitor 15 connected on the data line side. During this period, the erasing TFT 163 is in the OFF state, and hence charges in the holding capacitor 15, which is charged during the period (C), are held. As a result, the gate voltage of the driving TFT 162 changes by an amount of a difference between the data voltage V(i) and the reference voltage Vsl.

After that, the H level signal is input to the gate line 111 during the periods (E) and (F), and the L level signal is input to the gate line 112 during the periods (E) and (F). As a result, the ON state of the selecting TFT 161 and the OFF state of the erasing TFT 163 are maintained during the periods (E) and (F), and the gate voltage of the driving TFT 162 is held at a constant voltage during this period. Further, during this period, the H level signal is input to the gate line 1131, and the light emission period controlling TFT 1641 is in the ON state. As a result, a current corresponding to the gate voltage of the driving TFT 162 is supplied to the organic EL device 171, and the organic EL device 171 (first subpixel 101) emits light having luminance of gradation corresponding to the supplied current. Further, during this period, the L level signal is input to the gate line 1132, and the light emission period controlling TFT 1642 is in the OFF state. As a result, the organic EL device 172 is not turned ON, and light emission does not occur in the second subpixel 102.

In this embodiment, the organic EL device 171 in the first subpixel 101 is an organic EL device with the high front luminance, and hence during this light emission period (E), display with high front luminance is achieved.

(F) Non-Light Emission Period

During this period, the L level signals are input to the data lines 1131 and 1132, and the light emission period controlling TFTs 1641 and 1642 are in the OFF state. As a result, during this period, the organic EL devices 171 and 172 do not emit light.

In the drive performed by the above-mentioned driving sequence, during the light emission period (E), the first subpixel 101 emits light, but the present invention is not limited thereto. In the organic EL display apparatus of the present invention, by switching the ON/OFF states of the light emission period controlling TFTs 1641 and 1642 during the light emission period (E), the first subpixel 101 and the second subpixel 102 may be arbitrarily selected to emit light. For example, during the light emission period (E), the light emission period controlling TFT 1641 may be turned OFF and the light emission period controlling TFT 1642 may be turned ON, to thereby achieve display with large view angle.

Further, during the light emission period (E), the light emission period controlling TFTs 1641 and 1642 may be driven so as to be both turned ON. In this case, owing to the first subpixel 101 with the high front luminance, the front luminance can be increased, and owing to the second subpixel 102 with the large view angle, reduction of luminance in the oblique direction can be suppressed so that the view angle characteristics are improved. That is, while maintaining the view angle characteristics, the display with high light use efficiency is achieved.

Note that, the pixel circuit illustrated in FIG. 5 and the driving sequence illustrated in FIG. 6 are merely examples of the embodiment of the present invention, and the present invention is not limited to those pixel circuit and driving sequence.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

100 pixel

101 first subpixel

102 second subpixel

26 lens

171, 172 organic EL device

162 driving TFT

1641, 1642 light emission period controlling TFT

This application claims the benefit of Japanese Patent Application No. 2010-261917, filed Nov. 25, 2010, which is hereby incorporated by reference herein in its entirety.

What is claimed is:

1. An organic EL display apparatus, comprising multiple pixels,
each of the multiple pixels comprising:
a first subpixel and a second subpixel having the same hue and different optical characteristics;
an organic EL device corresponding to the first subpixel and an organic EL device corresponding to the second subpixel; and
a driving TFT for supplying a current to the organic EL device corresponding to the first subpixel and the organic EL device corresponding to the second subpixel,
wherein the first subpixel has a higher front luminance than the second subpixel,
wherein the first subpixel and the second subpixel of the each of the multiple pixels are independently controlled to emit light by the same gradation display signal, and
wherein the multiple pixels and the first subpixels of the multiple pixels are respectively arranged in a staggered pattern.

2. The organic EL display apparatus according to claim 1, wherein the first subpixel comprises a lens on a light extraction side of the organic EL device corresponding to the first subpixel.

3. The organic EL display apparatus according to claim 1,
wherein the each of the multiple pixels comprises:
a first light emission period controlling TFT for controlling a light emission period of the organic EL device corresponding to the first subpixel; and
a second light emission period controlling TFT for controlling a light emission period of the organic EL device corresponding to the second subpixel,
wherein the driving TFT supplies the current to one of the organic EL device corresponding to the first subpixel and the organic EL device corresponding to the second subpixel via corresponding one of the first light emission period controlling TFT and the second light emission period controlling TFT, and
wherein in each of the multiple pixels, between the first subpixel and the second subpixel, any one of a first gate line for controlling the first light emission period controlling TFT and a second gate line for controlling the second light emission period controlling TFT is disposed.
